(19) United States
(12) Patent Application Publication
(10) Pub. No.: US 2006/0090169 A1
(43) Pub. Date: Apr. 27, 2006

(54) Process to not disturb a user when performing critical activities

(75) Inventors: Fonda J. Daniels, Cary, NC (US); Bradford Austin Fisher, Chapel Hill, NC (US); David Bruce Kumhyr, Austin, TX (US); Robert Thomas Uthe, Morrisville, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 10/953,631

(22) Filed: Sep. 29, 2004

(51) Int. Cl. G06F 9/44

(52) U.S. Cl. 719/320; 719/329

(57) ABSTRACT

A method, system, and computer instructions for managing interruptions across applications in a data processing system. A user's focus is monitored within the data processing system. Responsive to a request to present a window in the foreground, the priority level of an application currently containing the user focus is compared with a priority level of an application presenting the window. If the application presenting the window has a higher or equal priority than the application currently containing the user focus, the window is presented in the foreground. If the application presenting the window has a lower priority than the application currently containing the user's focus, the request to present the window in the foreground is ignored. Information regarding the request is then stored in a log for later viewing.

### BACKGROUND OF THE INVENTION

1. Technical Field

The present invention relates generally to an improved data processing system. In particular, the present invention relates to a method, apparatus, and computer instructions for managing interruptions across applications in a data processing system.

2. Description of Related Art

Complex software systems generally include ways of interrupting a user to inform the user of something that is deemed important, usually via a window brought to the foreground to capture the user's attention. The interruption may take the form of, for example, a message box reporting a warning or error, an event display that jumps to the foreground when a severe event arrives, or an instant messaging session when a new message is received. These interruptions are desirable in certain circumstances, for they allow a user to pay attention to a wide variety of system activities, as well as rely on being informed when an event occurs that requires user action.

Although attracting the user's attention by bringing a window to the foreground is a useful tool, having windows pop up with messages while a user is working on other documents can be distracting and frustrating. For example, if a user is inputting information into a document in a word processing application and an instant message is received, a pop-up window containing the instant message grabs the focus of the desktop. The word processing document moves from the foreground to the background, while the pop-up window moves to the foreground. This situation can be problematic if the input the user is entering into the current application is redirected into the pop-up window, rather than the document. In addition, a user may be in the middle of a critical activity like diagnosing a severe web server outage. Any asynchronous update of this nature is a distraction from the critical activity, as well as consumes very valuable time.

In existing applications, a user may set a “do not disturb” or “away” preference to avoid this type of distraction. However, these preferences in existing systems are functions built internally to specific applications, such as instant messaging applications. There is currently no mechanism for controlling changes in focus for all applications that attempt to push a window to the foreground.

Therefore, it would be advantageous to have an improved method and apparatus for managing interruptions across applications in a data processing system.

### BRIEF SUMMARY OF THE INVENTION

The present invention provides a method, system, and computer instructions for managing interruptions across applications in a data processing system. A user's focus is monitored within the data processing system. Responsive to a request to present a window in the foreground, the priority level of an application currently containing the user focus is compared with a priority level of an application presenting the window. If the application presenting the window has a higher or equal priority than the application currently containing the user focus, the window is presented in the foreground. If the application presenting the window has a lower priority than the application currently containing the user's focus, the request to present the window in the foreground is ignored. Information regarding the request is then stored in a log for later viewing.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented in accordance with a preferred embodiment of the present invention;

FIG. 2 is a block diagram of a data processing system in which the present invention may be implemented;

FIG. 3 is a diagram illustrating components used in managing interruptions in accordance with the present invention;

FIG. 4 is an example preferences window for setting priorities of applications in accordance with the present invention;

FIG. 5 is an example history log comprising information recorded when the user is in a “do not disturb” mode in accordance with the present invention; and

FIG. 6 is a flowchart of the process for handling a request to move a window to the foreground in accordance with the present invention.

### DETAILED DESCRIPTION OF THE INVENTION

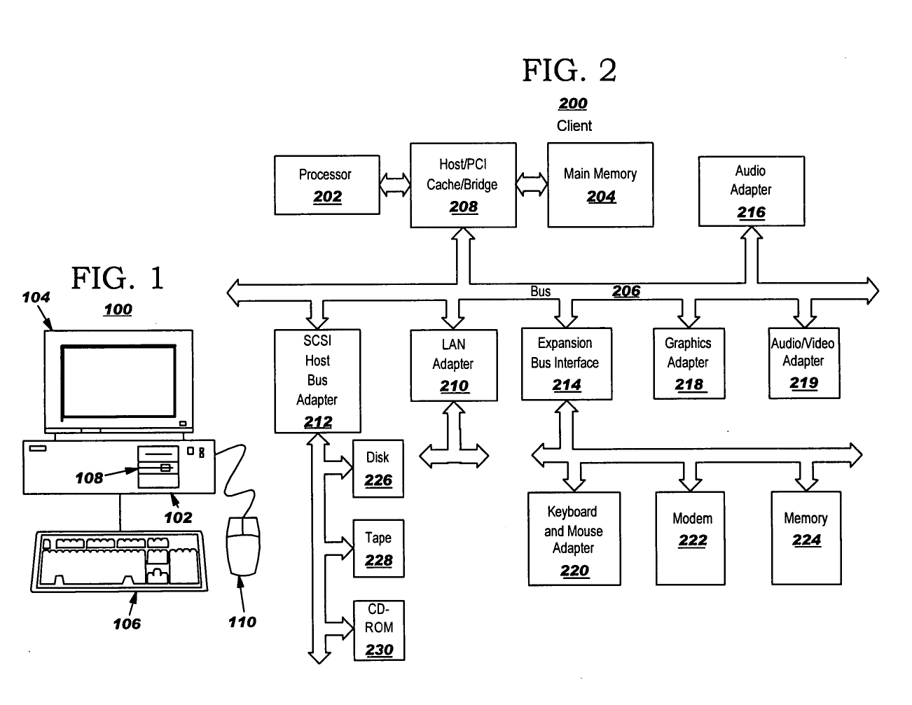

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y.. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation or Linux, which is available from Sun Microsystems, Inc. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. The processes of the present invention are performed by processor 202 using computer implemented instructions, which may be located in a memory such as, for example, main memory 204, memory 224, or in one or more peripheral devices 226-230. The processes of the present invention may also be implemented in a user interface (UI) framework, such as Integrated Solutions Console, Websphere Portal, Eclipse, or .NET, all products of International Business Machines Corporation. These frameworks allow for assembling the user interface from any number of disparate products and technologies into a single place.

The present invention provides a method, apparatus, and computer instructions that allow a user to place the user's system in a do-not-disturb mode. In particular, the present invention provides a rules-based system that allows a user to usurp the original programmed behaviors of the windows and display mechanism of the system. The mechanism of the present invention provides a user with the current window hierarchy and allows the user to apply rules to that hierarchy that affect the z-ordering, frame flashing, focus modes, etc. of the windows in the system. When the user's system is in a do-not-disturb mode, requests to move a window from a background to a foreground or to present a window in a foreground are ignored. This mechanism is especially useful for applications such as instant messaging applications, in which large amounts of activity may result in many windows, like pop-up windows, being moved to the foreground at different times. For instance, if a user is inputting information into a word processing document, the system monitors the user focus within the word processing document. If an instant messaging application grabs the window and keyboard focus, the system takes back the focus to the current application. The window may be moved to the foreground at a later point in time as the user permits.

A priority list of applications in relation to each other is used to determine whether the particular application in the foreground may be interrupted by a window for another application. This determination is based on user preferences set in the priority list. For example, the user may assign a higher priority to a word processing application and a slideshow presentation application than an instant messaging application. Thus, requests from the instant messaging application to interrupt the word processing and slideshow presentation applications will be ignored, while windows from the word processing and slideshow presentation applications may be moved and the instant messaging application in the foreground may be interrupted.

In addition, the system may enter the do-not-disturb mode on the user's behalf when the system knows the user is performing specific tasks. The system may discern that the current user task is time sensitive, critical in nature, or one that the user would appreciate an automatic do-not-disturb option. For example, if the user is using a computer for a customer slideshow presentation, the system may determine that the slideshow should not be interrupted, even though the user has not explicitly has not set such a preference.

In this manner, the mechanism of the present invention provides a way to avoid interruptions in focus across applications based on requests for windows to be moved to the foreground. This mechanism provides an advantage over the presently available “do not disturb” mechanisms built internally in specific applications.

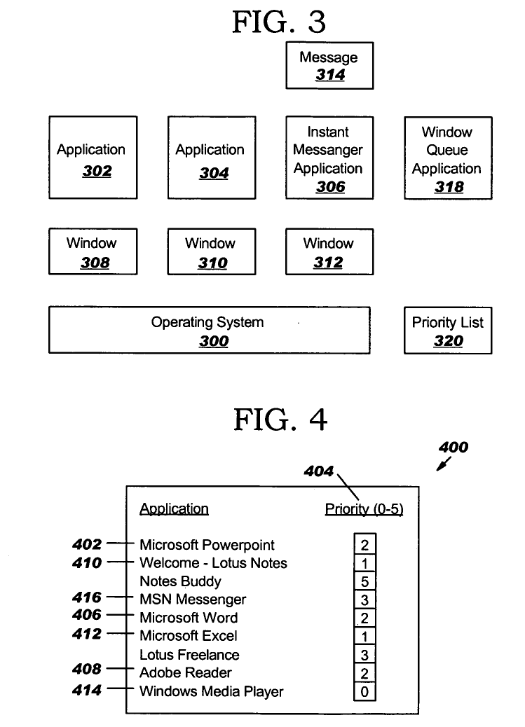

With reference next to FIG. 3, a diagram illustrating components used in managing interruptions is depicted in accordance with a preferred embodiment of the present invention. The different components illustrated in this figure may be executing on a data processing system, such as data processing system 200 in FIG. 2.

In this example, operating system 300 controls the execution of application 302, application 304 and application 306. In these examples, one application, such as application 302, executes in the foreground while the other applications, such as application 304 and application 306, execute in the background. An application executing the foreground is one in which a window for the application is visible and currently executing work or instructions. Such an application also is one that may be in focus. In other words, an application is in focus if it is accepting current keyboard input. An application executing in the background is an application whose window is not currently visible and is not in focus. As illustrated, window 308 is associated with application 302, window 310 is associated with application 304, and window 312 is associated with instant messenger application 306. Window 312 is a pop-up window in this example. If a message, such as message 314, is received by application 306, a request is sent by application 306 to operating system 300 to move window 312 to the foreground, which would result in window 308 being moved to the background.

In this illustrative example, operating system 300 includes a window queue application 318 for monitoring user focus. Window queue application 318 observes the current application in the foreground to determine the user's focus. Window queue application 318 may observe the user's focus using various methods such as monitoring keyboard input, tracking the mouse pointer, monitoring the input buffer, etc. When observing the user's focus, the application associated with the window in the foreground, application 302, is identified. The current active window may be identified using, for example, the Windows™ API call, GetActiveWindow( ), or using any similar API, such as X Windows™ toolkit or other windows toolkits. The Windows™ manager tracks the position of the windows instances and their z-order (how the windows are stacked on the screen), as well as the focus window and input window.

When the application associated with the window in the foreground is identified, the application is compared to a hierarchical list of applications, such as priority list 320. This hierarchical list identifies applications in operating system 300 according to their priority in relation to one another. In these examples, priority list 320 is generated from preferences set by a user. The user may set preferences regarding which applications have higher priorities in window queue application 318. Operating system 300 allows an application to take control of the user's focus and move a window, such as window 312, to the foreground if that application has been assigned a higher priority than the current application containing the user's focus. In contrast, if the current application containing the user's focus has a higher priority than the requesting application, window 312 is not moved to the foreground.

In addition to preventing a requesting application from interrupting a user by moving a window to the foreground, audio files associated with the requesting application may also be muted. The user may allow certain visual or audio displays, such as a flash frame window, to be used which inform the user that an application has attempted bring a window to the foreground. However, these displays do not interrupt or take the focus from the current application.

Furthermore, a toggle feature may also be provided to allow the user to toggle the current application to a do not disturb state. Using this option, the user may easily override the current user settings in priority list 302 by designating the current application as uninterruptible. In this manner, user focus is maintained at the current application despite other requesting applications having a higher priority than the current application.

Turning now to FIG. 4, an example preferences window for setting priorities of applications in accordance with the present invention is shown. Preferences window 400 may be presented to the user via window queue application 318 in FIG. 3. Preferences window 400 allows users to manage window interruptions by setting their systems in do-not-disturb mode. Preferences window 400 also allows users to apply priority levels to the applications. In this manner, users are given the ability to allow certain interruptions based on the priority of the application requesting a window be moved to the foreground.

In this illustrative example, preferences window 400 is shown to contain a list of applications, such as Microsoft Powerpoint 402. Preferences window 400 also contains priority levels associated with each application in the list, such as priority level 404. In this illustrative example, the priority levels range from 0 to 5, with applications having a user-defined priority level of 5 being the lowest priority, and applications with a user-defined priority level of 0 being the highest priority. Only applications having the same priority level or a higher priority level than an application currently containing the user focus may successfully interrupt the current application. For example, Microsoft Powerpoint 402 is shown to have a priority level of 2. Microsoft Word 406 and Adobe Reader 408, which have priority levels of 2, Welcome-Lotus Notes 410 and Microsoft Excel 412, which have priority levels of 1, and Window Media Player 414, which has a priority level of 0, are allowed to interrupt the user's focus from Microsoft Powerpoint 402. In this example, applications with a priority level equal to the current application's priority level (Microsoft Word 406 and Adobe Reader 408) are allowed to interrupt the current application. However, those applications with a priority level of 3, 4, or 5, such as MSN Messenger 416, are not allowed to interrupt the user's focus on Microsoft Powerpoint 402.

Although FIG. 4 provides a user-specified hierarchical list for determining whether the user's focus on an application may be interrupted by another application, the present invention also provides for allowing the system to enter the do-not-disturb mode on the user's behalf when the system knows the user is performing specific tasks. The system may discern that the current user task is time sensitive, critical in nature, or one that the user would appreciate an automatic do-not-disturb option. For example, if an automated software install is being performed where the install takes over mouse and keyboard control (e.g., using IBM Standard Software Installer (ISSI)), the system will prevent other windows from interrupting the install, even though the user has not explicitly has not set such a preference.

Although the example in FIG. 4 shows a particular preference display, one of ordinary skill in the art would recognize that other hierarchical preferences may be used in preferences window 400 to allow the user to usurp the original programmed behavior of the windows and display mechanism of the system.

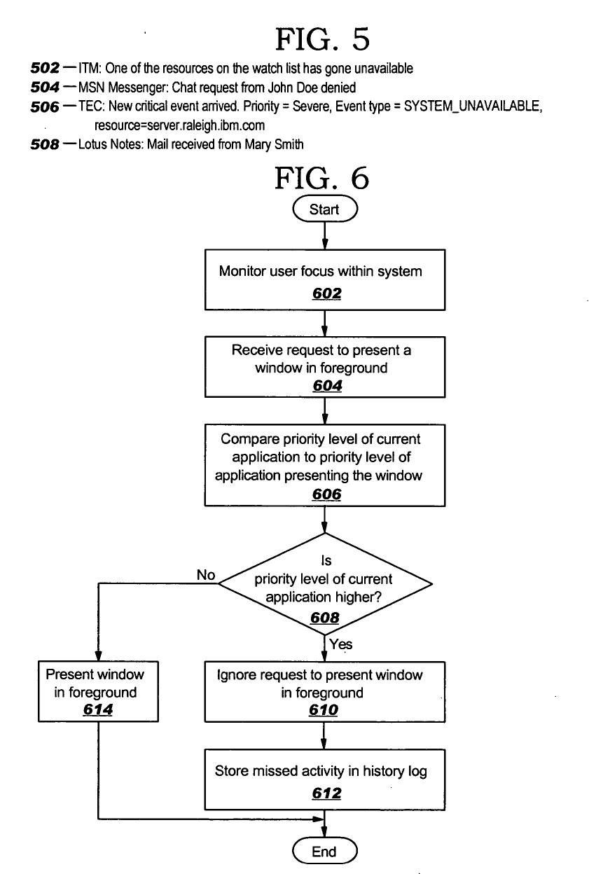

FIG. 5 is an example history log comprising information recorded when the user is in a “do not disturb” mode in accordance with the present invention. The history log in FIG. 5 may be maintained in a memory or storage device, such as memory 204 in FIG. 2. The history log comprises system activity that occurred but was not able to interrupt the user's focus from the current application. A user may access the information in the history log to discover what activities the user missed while being in the “do not disturb” state. For example, the history log is shown to contain four events: IBM Tivoli Enterprise Console (ITM) 502, MSN Messenger 504, Tivoli Enterprise Console (TEC) 506, and Lotus Notes 508. In particular, detail for MSN messenger 504 includes the information that John Doe requested an instant messaging session with the user, but the request was denied. Thus, using the history log, the user may still learn of missed activity that occurred while the user was in the uninterruptible state.

FIG. 6 is a flowchart of the process for handling a request to move a window to the foreground in accordance with the present invention. Prior to implementing the steps in FIG. 6, a user establishes a priority level for each application in the system. The process illustrated in FIG. 6 may be implemented in a software component, such as operating system 300 in FIG. 3.

The process begins with the window queue application monitoring a user's focus in the data processing system (step 602). When the operating system/window queue application receives a request to present a window in the foreground (step 604), the priority level associated with the application currently containing the user focus is compared to the priority level associated with the application presenting the window (step 606). A determination is then made as to whether the priority level associated with the application currently containing the user focus is higher than or equal to the priority level associated with the application presenting the window (step 608). If the priority level associated with the application currently containing the user focus is same priority level or higher, the operating system/window queue application maintains the user focus on the current application and ignores the request to move the window to the foreground (step 610). Information regarding missed activity is then stored in a history log (step 612), with the process terminating thereafter. The user may access this missed activity information at a later time.

If the priority level associated with the application currently containing the user focus is lower than the priority level associated with the application presenting the window, the window is presented in the foreground (step 614), with the process terminating thereafter.

Thus, the mechanism of the present invention provides a rules-based system for managing windows in a data processing system. This mechanism is applicable to any system in which a window may be moved from the background to the foreground or in which the window may be presented in the foreground. The mechanism monitors the user's focus in the currently executing application and determines, based on a set of rules, whether a request to bring a window to the foreground will be granted. These rules may be in the form of a priority list set by the user, or may be system-specified. This mechanism is especially useful with asynchronous pop-up windows, such as those used in instant messenger applications.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing interruptions across applications, comprising:
monitoring a user focus in the data processing system;
responsive to a request to present a window in the foreground, comparing a priority level of an application currently containing the user focus with a priority level of an application presenting the window; and
presenting the window in the foreground if the application presenting the window has one of a higher or equal priority than the application currently containing the user focus.

2. The method of claim 1, further comprising:
ignoring the request to present the window in the foreground if the application presenting the window has a lower priority than the application currently containing the user focus; and
storing information regarding the request in a log.

3. The method of claim 1, wherein the priority levels are defined by a user.

4. The method of claim 1, wherein the priority levels are system defined.

5. The method of claim 2, wherein ignoring the request to present the window in the foreground includes muting audio sounds associated with the window.

6. The method of claim 2, wherein ignoring the request to present the window in the foreground includes displaying a flash frame window, wherein the flash frame window informs a user that a request to present the window has occurred.

7. The method of claim 1, wherein the priority levels of applications in relation to each other in the data processing system are contained in a priority list.

8. The method of claim 7, wherein a user overrides settings in the priority list using a toggle feature.

9. A data processing system for managing interruptions across applications, comprising:
monitoring means for monitoring a user focus in the data processing system;
comparing means for comparing a priority level of an application currently containing the user focus with a priority level of an application presenting the window in response to a request to present a window in the foreground; and
presenting means for presenting the window in the foreground if the application presenting the window has one of a higher or equal priority than the application currently containing the user focus.

10. The data processing system of claim 9, further comprising:
ignoring means for ignoring the request to present the window in the foreground if the application presenting the window has a lower priority than the application currently containing the user focus; and
storing means for storing information regarding the request in a log.

11. The data processing system of claim 9, wherein the priority levels are defined by a user.

12. The data processing system of claim 9, wherein the priority levels are system defined.

13. The data processing system of claim 10, wherein ignoring the request to present the window in the foreground includes muting audio sounds associated with the window.

14. The data processing system of claim 10, wherein ignoring the request to present the window in the foreground includes displaying a flash frame window, wherein the flash frame window informs a user that a request to present the window has occurred.

15. The data processing system of claim 9, wherein the priority levels of applications in relation to each other in the data processing system are contained in a priority list.

16. The data processing system of claim 15, wherein a user overrides settings in the priority list using a toggle feature.

17. A computer program product in a computer readable medium for managing interruptions across applications, comprising:
first instructions for monitoring a user focus in the data processing system;
second instructions for comparing a priority level of an application currently containing the user focus with a priority level of an application presenting the window in response to a request to present a window in the foreground; and
third instructions for presenting the window in the foreground if the application presenting the window has one of a higher or equal priority than the application currently containing the user focus.

18. The computer program product of claim 17, further comprising:
fourth instructions for ignoring the request to present the window in the foreground if the application presenting the window has a lower priority than the application currently containing the user focus; and
fifth instructions for storing information regarding the request in a log.

19. The computer program product of claim 17, wherein the priority levels are defined by a user.

20. The computer program product of claim 17, wherein the priority levels are system defined.

21. The computer program product of claim 18, wherein ignoring the request to present the window in the foreground includes muting audio sounds associated with the window.

22. The computer program product of claim 18, wherein ignoring the request to present the window in the foreground includes displaying a flash frame window, wherein the flash frame window informs a user that a request to present the window has occurred.

23. The computer program product of claim 17, wherein the priority levels of applications in relation to each other in the data processing system are contained in a priority list.

24. The computer program product of claim 23, wherein a user overrides settings in the priority list using a toggle feature.
